(19) United States
(12) Patent Application Publication
(10) Pub. No.: US 2026/0253430 A1
(43) Pub. Date: Aug. 27, 2026

(54) ROAD GEOMETRY DETECTION

(71) Applicant: TOYOTA RESEARCH INSTITUTE, INC., Los Altos, CA (US)

(72) Inventors: CARL MARCUS GREIFF, Mountain View, CA (US); OMORUYI EGHOSA ATEKHA, Palo Alto, CA (US); JOHN K. SUBOSITS, Mountain View, CA (US)

(73) Assignees: TOYOTA RESEARCH INSTITUTE, INC., Los Altos, CA (US); TOYOTA JIDOSHA KABUSHIKI KAISHA, Toyota-shi (JP)

(21) Appl. No.: 19/061,395

(22) Filed: Feb. 24, 2025

(51) Int. Cl. G06V 20/56; B60R 16/023; G06V 10/762; G06V 10/766; G06V 10/82

(52) U.S. Cl. CPC G06V 20/588; G06V 10/762; G06V 10/766; G06V 10/82; B60R 16/0231

(57) ABSTRACT

A system includes first sensor systems that obtain first sensor data. The system includes second sensor systems that obtain second sensor data. The first sensor data includes one or more indicia or features having a nonzero probability of comprising the indicia within a threshold distance of the ego vehicle. The second sensor data includes inertial or odometry data corresponding to the one or more indicia. The system performs operations including transforming the first sensor data, ingesting the first sensor data into one or more neural networks that obtain one or more prediction outputs associated with the indicia, obtaining prediction outputs, clustering at least a portion of the prediction outputs, aligning the one or more clustered prediction outputs based on the second sensor data, performing a regression on the aligned one or more clustered predictions, and generating a regressed output based on the regression.

### TECHNICAL FIELD

The present disclosure relates generally to road geometry detection, such as detecting lanes and lane boundaries. Some aspects of the disclosure relate to situations in which rapid detection is beneficial.

### DESCRIPTION OF RELATED ART

In autonomous or semi-autonomous vehicle operation, road geometry may be predicted or detected by extracting certain features from visual images and performing further computations. However, technology of detecting road geometry is currently insufficient and/or slow.

### BRIEF SUMMARY OF THE DISCLOSURE

According to various embodiments of the disclosed technology, a vehicle system associated with a vehicle (e.g., an ego vehicle) comprises one or more first sensor systems configured to obtain first sensor data and one or more second sensor systems configured to obtain second sensor data. The first sensor data comprises one or more indicia or features having a nonzero probability of comprising the indicia. The indicia or the features are within a threshold distance of the ego vehicle. The one or more first sensor systems comprise a camera. The second sensor data comprising inertial or odometry data corresponding to the one or more indicia. The system comprises one or more computing components such as computing processors. The system comprises a memory storing instructions that, when executed by the one or more computing components, cause the system to perform operations. The operations include transforming the first sensor data; ingesting the first sensor data into one or more neural networks configured to obtain one or more prediction outputs associated with the indicia; obtaining the one or more prediction outputs indicative of one or more predictions regarding an existence or an absence of the indicia corresponding to different physical locations or regions and one or more prediction parameters from the one or more neural networks; clustering the predictions based on the one or more prediction parameters; aligning the clustered predictions based on the second sensor data; performing a regression on the aligned clustered predictions; and generating a regressed output based on the regression.

In some embodiments, the indicia comprises one or more features associated with a geometry of a road traversed by the ego vehicle.

In some embodiments, the indicia comprises one or more lane boundaries.

In some embodiments, the second sensor data comprises data or signals from an inertial measurement unit (IMU) and from a Controller Area Network (CAN) bus.

In some embodiments, the transforming of the first sensor data comprises unwarping the first sensor data.

In some embodiments, the transforming of the first sensor data comprises converting the first sensor data into a grid format, the grid comprising cells representing different physical regions.

In some embodiments, the one or more prediction parameters comprise a confidence head, an embedding head, an offset head, and an elevation head, wherein the confidence head indicates a likelihood that a particular cell contains an instance of the indicia, the embedding head indicates one or more embedding parameters that define a mapping of the transformed first sensor data into an embedding space or that define the embedding space, such that instances of the indicia having common categorizations are mapped into a same embedding space, the offset head indicates a bias of a proportion of a cell that is inside or outside of the instance of the indicia in a lateral direction, and the elevation head indicates a bias of an elevation of the instance of the indicia.

In some embodiments, the clustering is based on a principal component analysis (PCA).

In some embodiments, the indicia comprises one or more lane boundaries; and the clustering is based on an assumption that a maximum number of lane boundaries is two.

In some embodiments, the regressing comprises generating a parametric representation of instances of the indicia and a distribution that indicates a confidence level of the generated parametric representation.

In some embodiments, the parametric representation is based on a Bezier curve.

In some embodiments, the vehicle system comprises a database system, and at least some of the aforementioned operations are performed remotely from the system. For example, at least some of the aforementioned operations may be performed by a different database system and/or an external system such as a cloud or edge computing system. The system may obtain one or more results of the aforementioned operations via communication with the different database system and/or the external system.

According to various embodiments of the disclosed technology, a vehicle control system comprises one or more computing components, the one or more computing components comprising one or more neural networks; and a memory storing instructions that, when executed by the one or more computing components, cause the system to perform operations. The operations comprise obtaining, from one or more first sensor systems, first sensor data, the first sensor data comprising one or more indicia or features having a nonzero probability of comprising the indicia within a threshold distance of the ego vehicle, wherein the one or more first sensor systems comprise a camera; transforming the first sensor data; ingesting the first sensor data into the one or more neural networks configured to obtain one or more predictions associated with the indicia; obtaining one or more prediction outputs indicative of one or more predictions regarding an existence or an absence of the indicia corresponding to different physical locations or regions and one or more prediction parameters from the one or more neural networks; clustering the predictions based on the one or more prediction parameters; aligning the clustered predictions based on the second sensor data; performing a regression on the aligned clustered predictions; and generating a regressed output based on the regression.

Previous features described with respect to the vehicle system may also be applicable to the vehicle control system.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3 illustrates an example architecture for detecting road geometry, including associated sensors and sensing systems.

FIG. 4 is a block diagram illustrating an example implementation of a road geometry detecting component (e.g., a computing component that performs detecting of road geometry).

FIG. 5 illustrates an example implementation of different components of the road geometry detecting component, including the sensor data transforming component, the predicting component, the clustering component, the aligning component, and the regressing component.

FIG. 6 illustrates an example neural network that outputs one or more predictions.

FIG. 7 illustrates one embodiment of the method for computing clustered predictions from a visual feed of images.

FIG. 8 shows the embedding head of a prediction visualized in a two-dimensional space where two clusters and are visible.

FIG. 9 illustrates how the clustered predictions are aligned temporally prior to the regression.

FIG. 10 illustrates how processed inputs and clustered predictions are further processed to generate a regressed output of the lane boundaries.

FIG. 11 illustrates regressed road geometry predictions from single models, ensemble predictions, and ground truth road-boundary labels.

FIG. 12 illustrates one embodiment of a fast clustering algorithm, where unclustered predictions are received from the neural network predictor.

FIG. 13 is an example computing component that may be used to implement various features of embodiments described in the present disclosure.

The figures are not exhaustive and do not limit the present disclosure to the precise form disclosed.

### DETAILED DESCRIPTION

Improved techniques of road geometry may address potential limitations associated with current road geometry detection or prediction (hereinafter “detection”). First, sensor data may be captured. The captured sensor data may be from different sensors or sensor systems and/or modalities, such as one or more cameras (e.g., camera feeds), Lidars, radars, inertial or odometry sensors such as inertial measurement units (IMUs), and Controller Area Network (CAN) bus signals. Here, sensor systems may refer to one or more sensors and/or any associated processing components (e.g., software, hardware, and/or firmware) to process raw sensor data captured by the sensors. The captured sensor data may be asynchronous and/or captured from different perspectives. The captured sensor data may include two-dimensional (2D) sensor data. The captured sensor data may be transformed. Examples of transformation may include unwarping and/or removing distortions. The transformed captured sensor data may be fed into models such as one or more neural networks. Each of the models may output one or more predictions which may be manifested as embeddings in a feature space. At least a portion of the models may include different models, different model types, and/or be trained using different datasets or protocols. The embeddings represent clusters indicative of predicted locations of certain indicia, such as lane boundaries or demarcations (hereinafter “boundaries”). The clusters may be aligned temporally and/or across different sensors to synchronize any asynchronous feeds, using inertial or odometry data such as IMU data and/or CAN bus signals. The aligned clusters may be transformed, for example, using one or more transforms (e.g., a SE(3) transform) that employ a transformation matrix that include a rigid body transformation, such as a translation and/or rotation, to synchronize different frames of sensor data. One or more of the aligned clusters may be fed into a regressor that operates to generate a parametric representation of the indicia, along with a distribution over lane parameters that indicate a confidence level, probability, or reliability level (hereinafter “confidence level”) of the predicted locations of the indicia.

In some embodiments, the aforementioned technique performs outputting of predictions at rates exceeding 380 Hertz (Hz) and clustering at rates exceeding 1.2 kHz, and may be performed on computing components such as one or more graphics processing units (GPUs). This permits rapid detection of indicia such as lane boundaries during dynamic scenarios such as driving and/or racing, and/or provides reliable detection of complex and/or changing road geometries. Such rapid and accurate detection improves safety and reliability of vehicles such as autonomous or semi-autonomous vehicles (hereinafter “autonomous vehicles” or “AVs”) vehicle computing systems, and/or features such as Advanced Driver Assistance Systems (ADAS), while expanding situations in which autonomous vehicles can be reliably used or deployed. The rapid outputting and clustering represents an improvement in computing technology, which provide much faster outputs using fewer computer resources. As a result, load balancing between different computing components, and/or avoidance of overburdening the computing components, is achieved. The aforementioned technique addresses previous shortcomings of being unable to reliably detect indicia during dynamic scenarios.

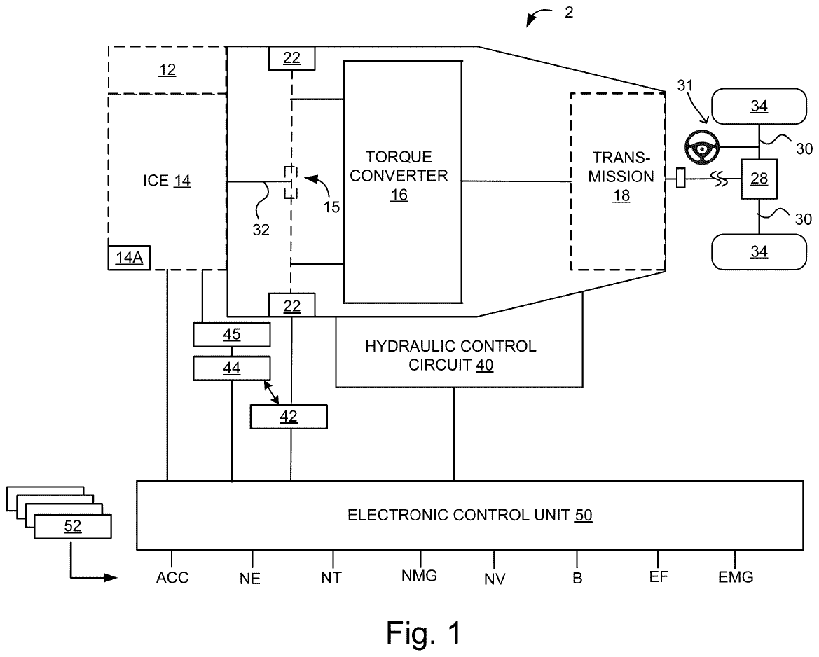

The systems and methods disclosed herein may be implemented with any of a number of different ego vehicles and ego vehicle types. The described ego vehicle and/or ego vehicle types may be at least semi-autonomous, and/or may have certain autonomous features. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for driver fitness assessment can be implemented in other types of ego vehicles including gasoline-or diesel-powered vehicles, fuel-cell vehicles, electric vehicles, or other vehicles.

FIG. 1 illustrates a drive system of an ego vehicle 2 that may include an internal combustion engine 14 and one or more motors 22 (e.g., electric motors, which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30. The ego vehicle 2 may include a steering system 31. The steering system 31 may be implemented via electronic power steering (EPS) or steer-by-wire.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and braking. As a more particular example, output torque of the motor 22 can be increased or decreased by electronic control unit 50 through the inverter 42. In some embodiments, the electronic control unit 50 may control the steering system 31.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to electronic control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. In some embodiments, sensors 52 may detect navigation characteristics of the ego vehicle 2. Here, navigation characteristics may include an absolute position, an absolute velocity, an absolute heading, or an absolute acceleration of the ego vehicle 2 or of the obstacle.

In some embodiments, one or more of the sensors 52 may include, or be part of, sensor systems which include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

As evident, sensors 52 may be included to detect not only vehicle conditions but also to detect external conditions, such as of other obstacles and/or indicia such as boundaries (e.g., lane boundaries) as well. Sensors that might be used to detect external conditions can include, for example, sonar, radar, lidar or other vehicle proximity sensors, and cameras or other image sensors. Image sensors can be used to detect, for example, objects such as traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 52 may be within an interior of, or on an exterior of the ego vehicle 2. The sensors 52 may include impairment detecting sensors, such as in-cabin cameras, eye tracking sensors, and steering wheel monitoring systems. In particular, interior or in-cabin cameras may include infrared cameras that monitor an occupant's eyes, face, and/or head to assess a measure of eye, facial, or head movements and/or a degree of stability or eye, facial, or head movements.

The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

The sensors 52 may also include one or more IMUs which may be configured to output signals such as gyroscopic measurements. These signals may be used to synchronize asynchronous sensor data.

The ego vehicle 2 may operate under different levels of autonomy, such as any of Society of Automotive Engineers (SAE) levels between L1 and L5. In some embodiments, the ego vehicle 2 may operate under a level of autonomy, such as L1 or L2, that includes or supports Vehicle-to-Everything (V2X) or Vehicle-to-Vehicle (V2V) communication functionality, and/or other functionalities such as ADAS functionality.

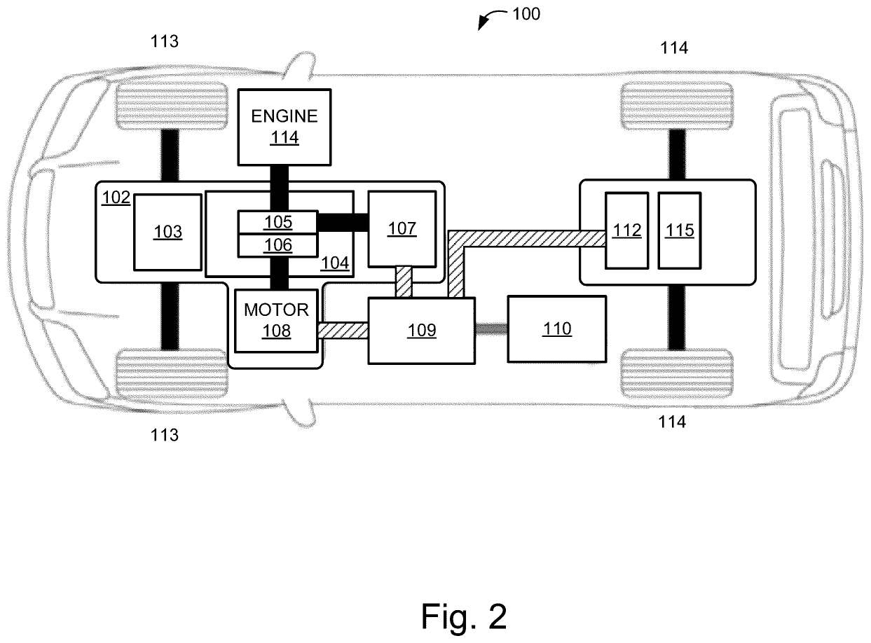

FIG. 2 is another example of an ego vehicle with which systems and methods for assessing occupant fitness can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. An ego vehicle may include all or a portion of the components illustrated in FIG. 1 or 2. Other variations of vehicles, such as gasoline powered vehicles, may also be implemented. Any vehicles may be implemented with vehicle platforms.

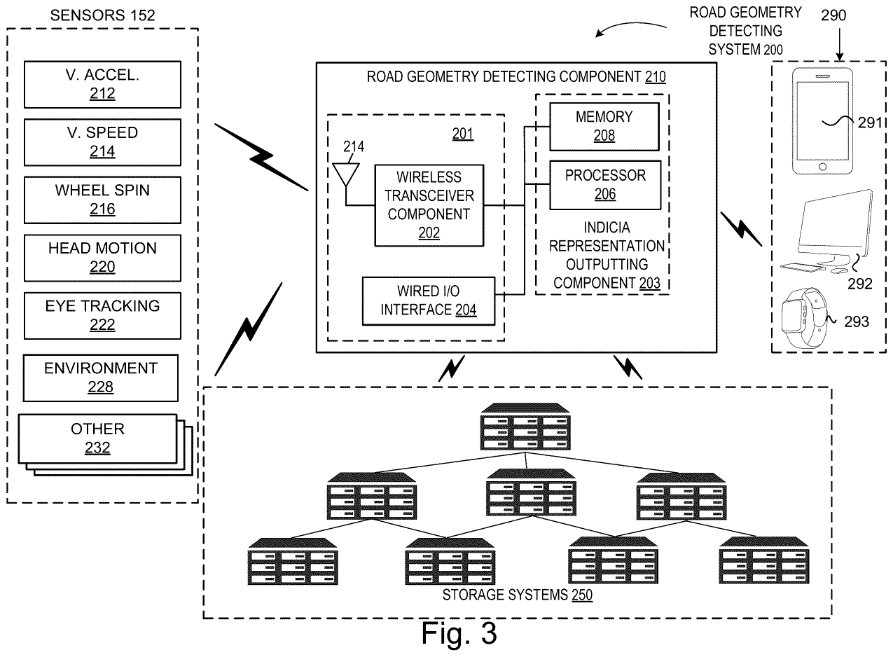

FIG. 3 illustrates an example architecture of a road geometry detecting system 200 for efficiently and accurately detecting road geometry including indicia such as lane boundaries, other traffic or lane markings, and/or road boundaries within a threshold distance of the ego vehicle 2. In some embodiments, the threshold distance may be a certain distance in front of the ego vehicle 2, and/or may be a certain radius surrounding the ego vehicle 2. The threshold distance can be any numerical value (e.g., 10 meters, 50 meters, 100 meters, 500 meters, 1000 meters, 5000 meters, 10000 meters or any other numerical value or range), any variable value, and/or may be based on sensor capabilities. For example, the detecting of a road geometry may be triggered, activated, scheduled, or expedited upon the sensor system detecting indicia and/or at least a nonzero or threshold likelihood of an instance or occurrence of the indicia). In some embodiments, the threshold distance may be based on one or more characteristics of the ego vehicle 2, such as navigation characteristics. Road geometry detecting system 200 may include a computer system or database system, and may further include a road geometry detecting component 210 which may perform operations such as transforming input sensor data, predicting or obtaining a prediction, clustering one or more outputs of the prediction, aligning the clustered outputs, and regressing the aligned and clustered outputs. The road geometry detecting system 200 and/or the road geometry detecting component 210 may further include an indicia representation outputting component 203 which generates and/or outputs one or more indicia, representations, or other indications indicative of a presence and/or an absence of detected indicia.

In some embodiments, any or a portion of the aforementioned or subsequently described techniques or operations may be performed by the road geometry detecting system 200, the road geometry detecting component 210, and/or the indicia representation outputting component 203, which may be onboard or otherwise associated with the ego vehicle 2. In some embodiments, any or a portion of the aforementioned techniques or operations may be performed using one or more external systems such as external database systems, an external cloud system and/or edge system. One or more results generated or obtained by the one or more external systems may be transmitted to any of the road geometry detecting system 200, the road geometry detecting component 210, and/or the indicia representation outputting component 203.

In some embodiments, based on outputted indicia or indicia representations, which may include one or more predicted lane boundaries, the road geometry detecting component 210, or a different component of the road geometry detecting system 200, may perform one or more navigation actions on the ego vehicle 2. The performing of one or more navigation actions, in some embodiments, may include controlling, programming, causing, and/or implementing one or more navigation actions of the ego vehicle 2. The one or more navigation actions may set or change a navigation characteristic of the ego vehicle 2 (e.g., an ego vehicle navigation characteristic). For example, if the ego vehicle 2 is programmed to maintain a certain threshold distance or range of threshold distances, from an indicia such as a detected lane boundary, then the ego vehicle 2 may adjust a navigation characteristic to maintain the distance. As another example, the ego vehicle 2 may be programmed to change its threshold distance or range of threshold distances based on a degree of confidence associated with the outputted indicia or indicia representations. For example, if the degree of confidence exceeds a threshold level, then the ego vehicle 2 may be programmed to stay within a threshold distance and/or maintain at least a threshold distance of the outputted indicia.

In other examples, the road geometry detecting component 210, or a different component of the road geometry detecting system 200, may impose speed limits of the ego vehicle 2, and/or other navigation limits such as a turning radius limit, a turning limit for a steering wheel, and/or force limits on actuators such as brakes, which were previously not imposed, based on the detected indicia, and/or one or more parameters of the detected indicia. In other examples, the road geometry detecting component 210 may selectively program the ego vehicle 2 to pull over, stop, or shut down depending on the parameters of the obstacle.

The road geometry detecting system 200, the road geometry detecting component 210, and/or the indicia representation outputting component 203, can be implemented as an ECU or as part of an ECU such as, for example electronic control unit 50. In other embodiments, the road geometry detecting system 200, the road geometry detecting component 210, and/or the indicia representation outputting component 203 can be implemented independently of the ECU. The road geometry detecting component 210 in this example includes a communication component 201, and the indicia representation outputting component 203 (including a processor 206 and memory 208 in this example). Components of the road geometry detecting component 210 are illustrated as communicating with each other via a data bus, although other communication in interfaces can be included.

The road geometry detecting system 200 may include or be associated with (e.g., communicating with) a plurality of sensors 152, one or more storage systems 250 which may include servers within or associated within the ego vehicle 2, and one or more other devices 290 which may be external to or internally located within the ego vehicle 2. The one or more storage systems 250 may store any of the previously aforementioned data including, but not limited to, any current or historical indicia data (e.g., any final or intermediate outputs indicative of a presence and/or absence of the indicia and associated confidence levels, any output heads, any current or historical parameters of the ego vehicle 2, and/or records of one or more navigation actions of the ego vehicle 2.

In some embodiments, the one or more other devices 290 include one or more different computing or mobiles devices 291, 292, and/or 293, and may be configured to receive a subset (e.g., a portion or all of) outputs from the road geometry detecting component 210, and/or the indicia representation outputting component 203, either in real-time or in a delayed manner via V2N communication.

Sensors 152, storage systems 250, and one or more other devices 290 can communicate with the road geometry detecting component 210 via a wired or wireless communication interface. Although sensors 152, storage systems 250 and one or more other devices 290 are depicted as communicating with the road geometry detecting component 210, they can also communicate with each other as well as with other vehicle systems.

Returning to the road geometry detecting system 200, the sensors 152 can include, for example, sensors 52 such as those described above with reference to the example of FIG. 1. Sensors 152 can include additional sensors. In the illustrated example, sensors 152 may include state detecting sensors which detect changes in state or status of a road, such as a diversion and/or a fork. These changes in state may trigger the road geometry detecting system 200 to perform an action such as detecting any changes in the road geometry, and/or increase a speed or level of urgency at which the road geometry detecting system 200 detects the changes in the road geometry.

The sensors 152 may include vehicle acceleration sensors 212, vehicle speed sensors 214, wheel speed sensors 216 (e.g., one for each road wheel), head motion sensors 220 to detect rotational and/or translational motion of a head of a driver within the ego vehicle 2, eye tracking sensors 222 to detect eye movements of the driver, and environmental sensors 228 (e.g., to detect traffic density, speed of surrounding traffic, weather, air quality, and/or other environmental conditions). In some embodiments, sensor data from the environmental sensors 228 may trigger the road geometry detecting component 210 to perform an action such as detecting any changes in the road geometry, and/or increase a speed or level of urgency at which the road geometry detecting component 210 detects the changes in the road geometry. For example, if traffic density is high and/or the environment has hazy conditions, then the road geometry detecting component 210 may be triggered to detect road geometry and/or triggered to increase a speed or level of urgency at which the road geometry detecting component 210 detects the changes in the road geometry. Additional sensors 232 can also be included as may be appropriate for a given implementation of road geometry detecting system 200.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to detect road geometry or generate or output an indication or a representation, for processor 206 as well as any other suitable information. Memory 208 can be made up of one or more modules of one or more different types of memory, and may be configured to store data and other information as well as operational instructions that may be used by the processor 206.

Although the example of FIG. 3 is illustrated using processor and memory components, as described below with reference to components disclosed herein, the road geometry detecting system 200, including the road geometry detecting component 210 and/or the indicia representation outputting component 203, can be implemented utilizing any computing components and/or any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up the road geometry detecting system 200, the road geometry detecting component 210 and/or the indicia representation outputting component 203.

Communication component 201 includes either or both a wireless transceiver component 202 with an associated antenna 205 and a wired I/O interface 204 with an associated hardwired data port (not illustrated). As this example illustrates, communications with the road geometry detecting component 210 can include either or both wired and wireless communication components 201. Wireless transceiver component 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by the radar data augmenting component 210 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

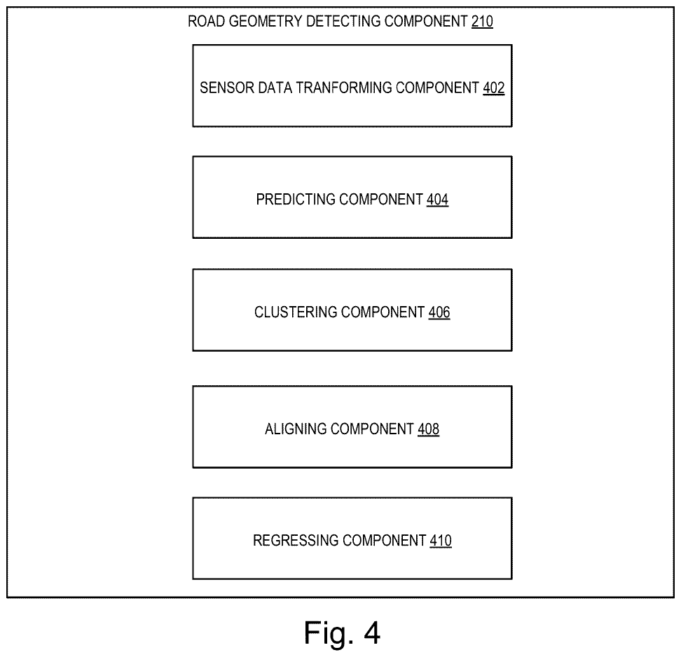

FIG. 4 is a block diagram illustrating an example implementation of the road geometry detecting component 210. In some embodiments, the road geometry detecting component 210 may include one or more computing components, including software, hardware, firmware, and/or one or more machine learning components such as neural networks. The road geometry detecting component 210 may include a sensor data transforming component 402, a predicting component 404, a clustering component 406, an aligning component 408, and/or a regressing component 410. In some embodiments, any of the aforementioned components may not be spatially or physically separated, but rather, combined into a single component or an integrated component.

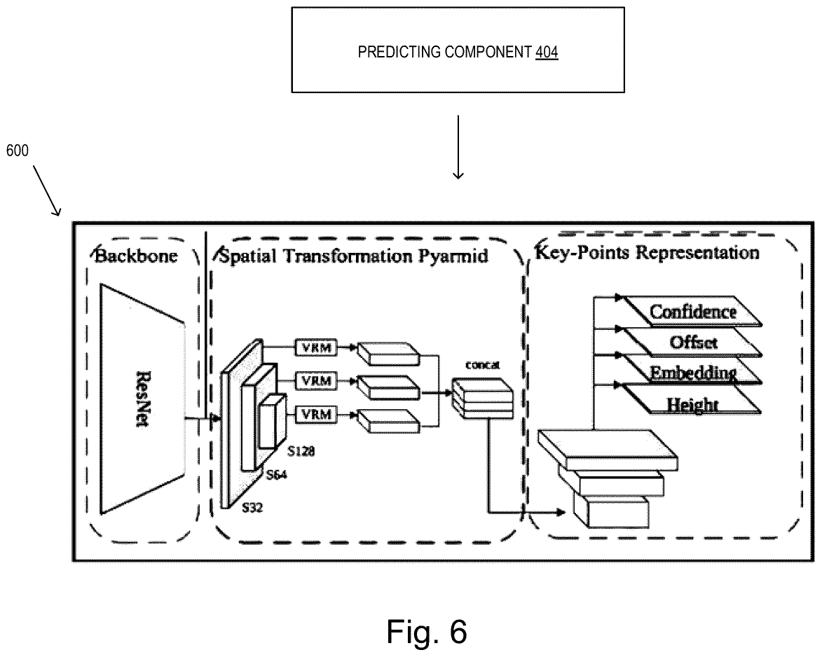

In some embodiments, the sensor data transforming component 402 may be configured to perform transforming of input sensor data (e.g., first sensor data) which includes one or more images from a camera (e.g., one or more monocular cameras). The transforming may include, for example, unwarping of distorted images. In some embodiments, the predicting component 404 may include one or more neural networks. One specific example of a neural network 600 that may be implemented as part of the predicting component 404 is illustrated in FIG. 6.

The neural networks may include a backbone to generate embeddings that are passed through a Spatial Transformation Pyramid or a Feature Pyramid Network (FPN). Different intermediary outputs in the FPN may be passed through a view relation module (VRM) and may be concatenated and convolved to output prediction heads.

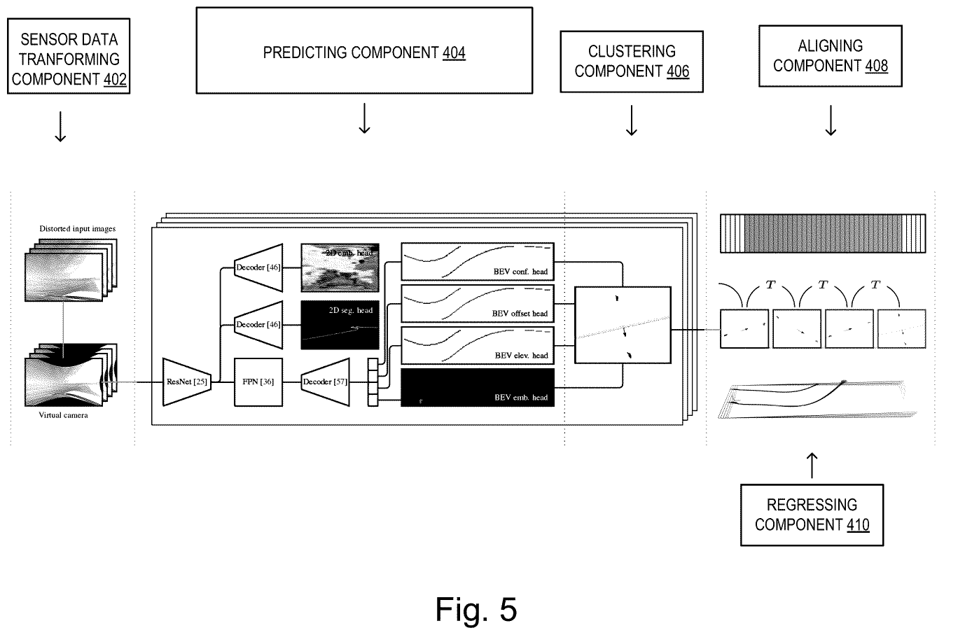

FIG. 5 illustrates an example implementation of the sensor data transforming component 402, the predicting component 404, the clustering component 406, the aligning component 408, and the regressing component 410.

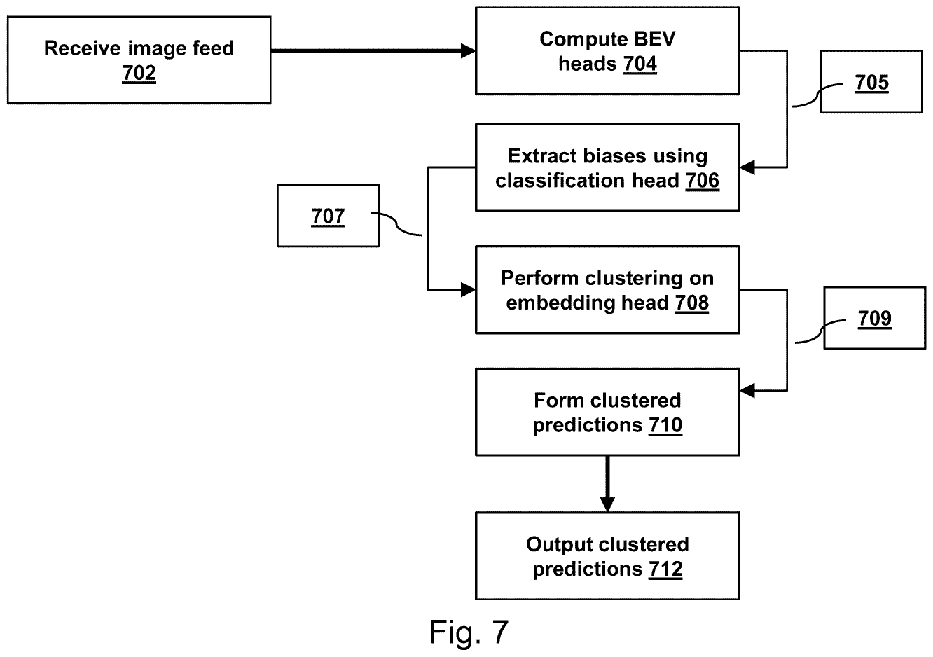

FIG. 7 illustrates one embodiment of the method for computing clustered predictions from a visual feed of images. One or multiple images are received in step 702 and these are passed through a neural network to compute a set of Birds-Eye View (BEV) prediction heads in step 704. In some embodiments, these heads contain biases pertaining to properties of specific cells in the BEV perspective. It is understood that these biases may include the elevation of the road in grid cells, the offset of the road boundary in the grid cells, and embeddings associated with the grid cells which can be used to determine if road geometry detected in one cell is similar to road geometry detected in another cell.

The predicted BEV heads are processed in a second module with extracts biases in step 706 using the classification head, which masking out the predictions that are irrelevant based on the classification head. In some embodiments, this drastically reduces the number of biases that need to be considered in the clustering method. The extracted biases are used as input to a clustering method in step 708, which clusters cells in the BEV space based on the embedding head. The clustered predictions are formed, and each cluster is assigned a specific lane type. It is understood that in the context of vehicle racing, this may be two lane types (inner and outer) whereas in other application with more lane boundaries, the lane boundaries may be labeled in other ways, including but not limited to integer numbers. It is understood that in some embodiments, the output of the clustering head forms clustered predictions 710 which may require post-processing to generate a set of clustered predictions in step 712 and outputted.

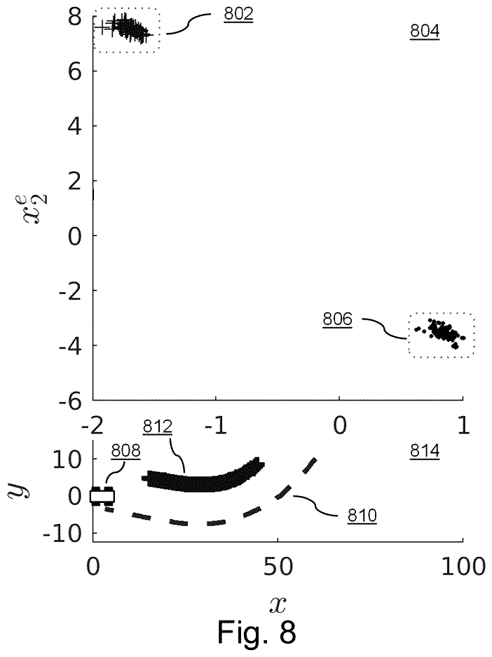

FIG. 8 shows the embedding head of a prediction 804 visualized in a two-dimensional space where two clusters 802 and 806 are visible. These clusters correspond to the lane boundaries depicted in 814, with an inner lane boundary 812 and an outer lane boundary 810 both depicted in a top-down in a BEV perspective in relation to a vehicle 808, which may be implemented as the ego vehicle 2. Points that are close in the embedding space, as manifested by the prediction 804, correspond to points in the BEV perspective that correspond to the same lane boundary. For example, the points 802 are associated with biases that can be used to form the lane boundary 812, and the points 816 are associated with predicted biases that can be used to form the lane boundary 810.

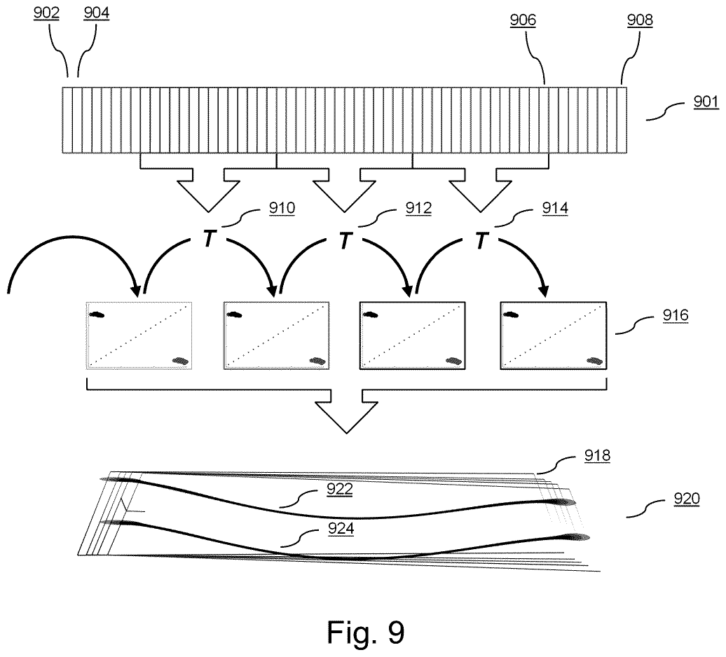

FIG. 9 illustrates how the clustered predictions are aligned temporally prior to the regression. The measurements from wheels, inertial measurements units or other sensors indicative of the vehicle state are stored in a buffer 901. Each element 902, 904 in the buffer 901 may be sorted in accordance to their sample time. From these measurements, a sequence of transforms 910, 912, and 914 are integrated. In some embodiments, these transforms are computed directly from measurements by integrating velocity signals, in other embodiments the transforms are computed from a filtering posterior generated by a state estimator. The transforms 910, 912, and 914 can be used to relate clustered predictions at different time steps. For example, if a clustered prediction is computed at a time step k and another is computers at a time step k+1, then the transform T permits a mapping of one clustered BEV prediction into the clustered BEV prediction of another. This is illustrated with the differently shaded boxes in 918. In some embodiments, the clustered predictions 916 are aligned temporally through the chain of transforms 910, 912, and 914 producing many clusters in the BEV perspective of the most recently sampled image, corresponding to a specific element 906 in the input buffer 901. In other embodiments, the clusters may be transformed to the most recent element in the input buffer 901. In other embodiments, the many clusters are transformed to the most recent element in the input buffer 901. The various predicted clusters are used to generate an ensemble prediction 920 of the different lane boundaries, 922, 924. In some embodiments, this is done by parametric regression.

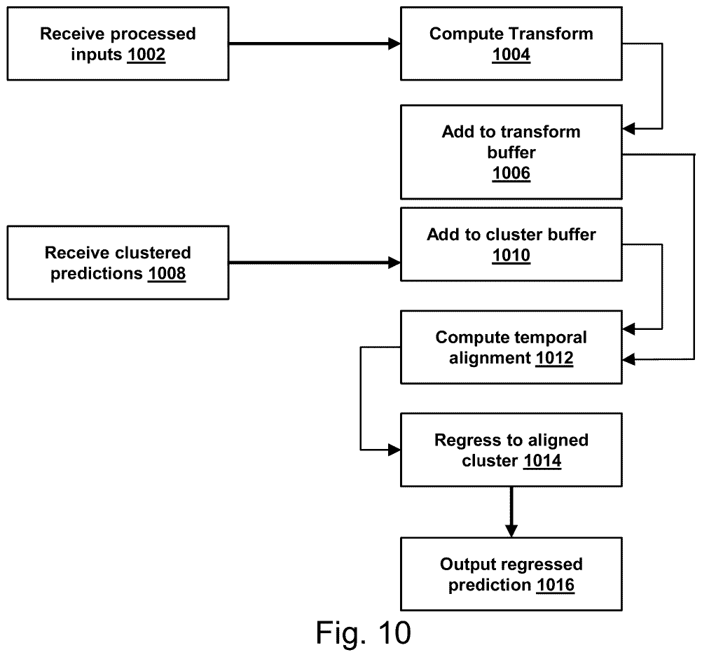

FIG. 10 illustrates how processed inputs, outputted from step 1002, and clustered predictions, as outputted from step 1008, can be further processed to generate a regressed output of the lane boundaries, outputted in step 1016. The received inputs are used to compute a transform in step 1004. This transform is added to a transform buffer in step 1006. The transforms relate the vehicle position and rotation at one point in time with the vehicle position and rotation at another point in time. Multiple such transforms can be multiplied to produce a transform that relates the vehicle position at a time that two consecutive images are sampled.

The clusters are received and added to a secondary buffer in step 1010, which stores clustered predictions and the time at which the image was sampled that produced the clustered prediction in step 1008. By using the transform buffer, a new transform can be computed to convert one cluster into the frame of another cluster. This is referred to as a temporal alignment computation, as computed in step 1012. The temporally aligned clusters are in the same physical frame, and we can therefore regress a unified parametric representation to these aligned clusters. The method outputs a distribution over the parameters of the lane boundaries as predicted in step 1016. In some embodiments, this is a Gaussian distribution over the coefficients of a parametric curve. In other embodiments, the regressed prediction may be represented by other distributions, such as Dirac mixtures and other particle representations.

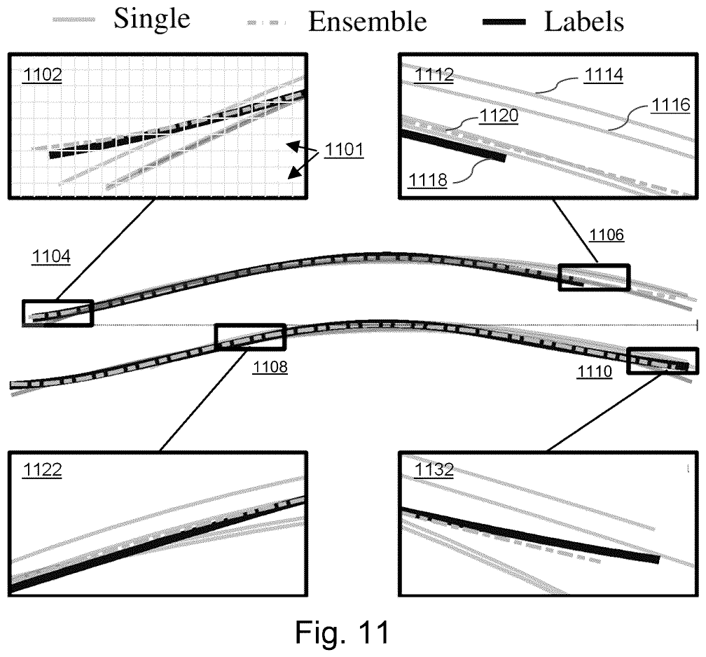

FIG. 11 illustrates regressed road geometry predictions from single models, ensemble predictions, and ground truth road-boundary labels 1102, 1112, 1122, and 1132. Each ground truth road-boundary label 1102, 1112, 1122, and 1132 may correspond to a particular segment 1104, 1106, 1108, and 1110, respectively. For example, the ground truth road-boundary label 1102 may correspond to a particular segment 1104. The single predictions 1114, 1116 may be less accurate, especially at long distances, and the ensemble predictions 1120 are generally closer to the ground truth labels 1112. The neural network predictions are done in a BEV perspective, which is partitioned into grid cells 1101. Each cell is associated with various biases that explain if a lane boundary is present in the cell, and if so, its relative spatial coordinate to the cell center.

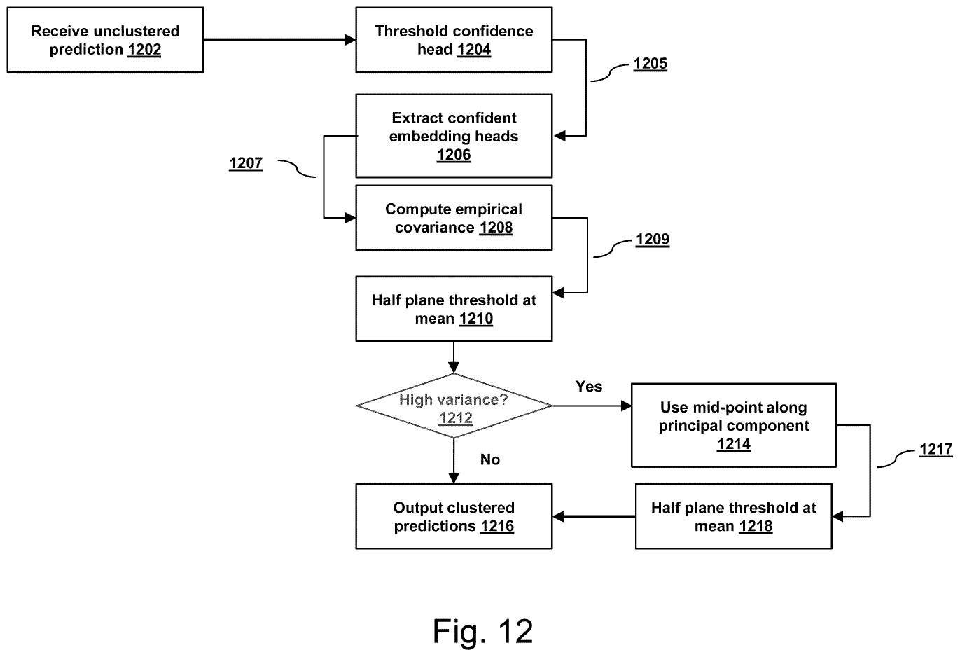

FIG. 12 illustrates one embodiment of a fast clustering algorithm, where unclustered predictions are received from the neural network predictor in step 1202. Based on the confidence head, a majority of the prediction is pruned away by a threshold on the confidence head in step 1204, producing a collection of points instead of a tensor in step 1206. With the remaining points, the sample covariance matrix is computed in step 1208, and factorized to produce a direction with maximal variation, the principal direction. A half plane is formed with a normal aligned with the principal direction, intersecting with the mean of all embeddings in the thresholded embeddings 1207. Based on this half plane, the clusters are categorized into clusters in step 1210. If the variance of each cluster is low along the principal direction, the clusters are returned directly in step 1216. However, if the variance is high, the half-plane used for threshold is instead constrained to intersect with the mid-point of the embeddings projected onto the principal direction in step 1214. Based on this new half plane, the embeddings clusters are categorized into clusters and returned in step 1218. It is understood that this last step is necessary when there are far fewer points in one cluster than another, which skews the mean of the embeddings toward the latter.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

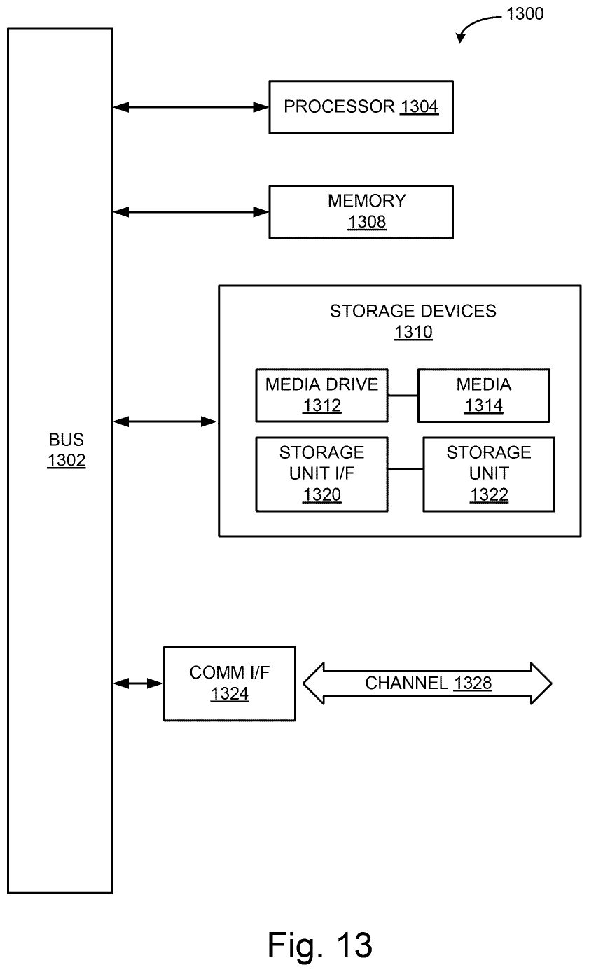

Referring now to FIG. 13, computing component 1300 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1300 might also represent computing capabilities embedded within or otherwise available to a given device. For example, a computing component might be found in other electronic devices such as, for example, portable computing devices, and other electronic devices that might include some form of processing capability.

Computing component 1300 might include, for example, one or more processors, controllers, control components, or other processing devices. This can include a processor, and/or any one or more of the components. Processor 1304 might be implemented using a general-purpose or special-purpose processing engine such as, for example, a microprocessor, controller, or other control logic. Processor 1304 may be connected to a bus 1302. However, any communication medium can be used to facilitate interaction with other components of computing component 1300 or to communicate externally.

Computing component 1300 might also include one or more memory components, simply referred to herein as main memory 1308. For example, random access memory (RAM) or other dynamic memory, might be used for storing information and instructions to be executed by processor 1304. Main memory 1308 might also be used for storing temporary variables or other intermediate information during execution of instructions to be executed by processor 1304. Computing component 1300 might likewise include a read only memory (“ROM”) or other static storage device coupled to bus 1302 for storing static information and instructions for processor 1304.

The computing component 1300 might also include one or more various forms of information storage mechanism 1310, which might include, for example, a media drive 1312 and a storage unit interface 620. The media drive 1312 might include a drive or other mechanism to support fixed or removable storage media 1314. For example, a hard disk drive, a solid-state drive, a magnetic tape drive, an optical drive, a compact disc (CD) or digital video disc (DVD) drive (R or RW), or other removable or fixed media drive might be provided. Storage media 1314 might include, for example, a hard disk, an integrated circuit assembly, magnetic tape, cartridge, optical disk, a CD or DVD. Storage media 1314 may be any other fixed or removable medium that is read by, written to or accessed by media drive 1312. As these examples illustrate, the storage media 1314 can include a computer usable storage medium having stored therein computer software or data.

In alternative embodiments, information storage mechanism 1310 might include other similar instrumentalities for allowing computer programs or other instructions or data to be loaded into computing component 1300. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 1300.

Computing component 1300 might also include a communications interface 624. Communications interface 624 might be used to allow software and data to be transferred between computing component 1300 and external devices. Examples of communications interface 624 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1308, storage unit 620, media 1314, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1300 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to a “threshold” or “sufficiency” may be construed to encompass any applicable value or degree, such as any applicable value or degree sufficient to satisfy a given outcome. In some examples, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity or degree may be construed as qualitatively satisfying some condition, such as presence of one or more common features. Any reference to sufficiently similar may also be construed to encompass same or similar meanings as satisfying a threshold. Reference to “likely,” “a likelihood,” or “probable” or any variation thereof may be construed as satisfying some threshold likelihood or probability.

In some embodiments, a threshold distance may refer to any distance in which an obstacle may have at least a threshold likelihood or probability of affecting one or more navigation actions or characteristics of the ego vehicle. In some embodiments, a threshold distance may refer to an acceptable following distance or maintaining distance according to one or more standards. For example, a threshold distance may include any distances equivalent to, or less than, 3 seconds, 10 seconds, or 20 seconds of travel at a current speed, and/or any subranges therein.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle system associated with an ego vehicle, the system comprising:
one or more first sensor systems configured to obtain first sensor data, the first sensor data comprising one or more indicia or features having a nonzero probability of comprising the indicia within a threshold distance of the ego vehicle, wherein the one or more first sensor systems comprise a camera;
one or more second sensor systems configured to obtain second sensor data, the second sensor data comprising inertial or odometry data corresponding to the one or more indicia;
one or more computing components;
a memory storing instructions that, when executed by the one or more computing components, cause the system to perform:
transforming the first sensor data;
ingesting the first sensor data into one or more neural networks configured to obtain one or more prediction outputs associated with the indicia;
obtaining the one or more prediction outputs indicative of one or more predictions regarding an existence or an absence of the indicia corresponding to different physical locations or regions and one or more prediction parameters from the one or more neural networks;
clustering the predictions based on the one or more prediction parameters;
aligning the clustered predictions based on the second sensor data;
performing a regression on the aligned clustered predictions; and
generating a regressed output based on the regression.

2. The system of claim 1, wherein the indicia comprises one or more features associated with a geometry of a road traversed by the ego vehicle.

3. The system of claim 2, wherein the indicia comprises one or more lane boundaries.

4. The system of claim 1, wherein the second sensor data comprises data or signals from an inertial measurement unit (IMU) and from a Controller Area Network (CAN) bus.

5. The system of claim 1, wherein the transforming of the first sensor data comprises unwarping the first sensor data.

6. The system of claim 1, wherein the transforming of the first sensor data comprises converting the first sensor data into a grid format, the grid comprising cells representing different physical regions.

7. The system of claim 6, wherein the one or more prediction parameters comprise a confidence head, an embedding head, an offset head, and an elevation head, wherein the confidence head indicates a likelihood that a particular cell contains an instance of the indicia, the embedding head indicates one or more embedding parameters that define a mapping of the transformed first sensor data into an embedding space or that define the embedding space, such that instances of the indicia having common categorizations are mapped into a same embedding space, the offset head indicates a bias of a proportion of a cell that is inside or outside of the instance of the indicia in a lateral direction, and the elevation head indicates a bias of an elevation of the instance of the indicia.

8. The system of claim 1, wherein the clustering is based on a principal component analysis (PCA).

9. The system of claim 8, wherein the indicia comprises one or more lane boundaries; and the clustering is based on an assumption that a maximum number of lane boundaries is two.

10. The system of claim 1, wherein the regressing comprises generating a parametric representation of instances of the indicia and a distribution that indicates a confidence level of the generated parametric representation.

11. The system of claim 10, wherein the parametric representation is based on a Bezier curve.

12. A vehicle control system associated with an ego vehicle, the system comprising:
one or more computing components, the one or more computing components comprising one or more neural networks;
a memory storing instructions that, when executed by the one or more computing components, cause the system to perform:
obtaining, from one or more first sensor systems, first sensor data, the first sensor data comprising one or more indicia or features having a nonzero probability of comprising the indicia within a threshold distance of the ego vehicle, wherein the one or more first sensor systems comprise a camera;
transforming the first sensor data;
ingesting the first sensor data into the one or more neural networks configured to obtain one or more predictions associated with the indicia;
obtaining one or more prediction outputs indicative of one or more predictions regarding an existence or an absence of the indicia corresponding to different physical locations or regions and one or more prediction parameters from the one or more neural networks;
clustering the predictions based on the one or more prediction parameters;
aligning the clustered predictions based on the second sensor data;
performing a regression on the aligned clustered predictions; and
generating a regressed output based on the regression.

13. The system of claim 12, wherein the first sensor data further comprises Lidar data.

14. The system of claim 13, wherein the indicia comprises one or more lane boundaries.

15. The system of claim 12, wherein the second sensor data comprises data or signals from an inertial measurement unit (IMU) and from a Controller Area Network (CAN) bus.

16. The system of claim 12, wherein the transforming of the first sensor data comprises unwarping the first sensor data.

17. The system of claim 12, wherein the transforming of the first sensor data comprises converting the first sensor data into a grid format, the grid comprising cells representing different physical regions.

18. The system of claim 17, wherein the one or more prediction parameters comprise a confidence head, an embedding head, an offset head, and an elevation head, wherein the confidence head indicates a likelihood that a particular cell contains an instance of the indicia, the embedding head indicates one or more embedding parameters that define a mapping of the transformed first sensor data into an embedding space or that define the embedding space, such that instances of the indicia having common categorizations are mapped into a same embedding space, the offset head indicates a bias of a proportion of a cell that is inside or outside of the instance of the indicia in a lateral direction, and the elevation head indicates a bias of an elevation of the instance of the indicia.

19. The system of claim 12, wherein the clustering is based on principal component analysis (PCA).

20. The system of claim 19, wherein the indicia comprises one or more lane boundaries; and the clustering is based on an assumption that a maximum number of lane boundaries is two.
